(19) United States
(12) Patent Application Publication
(10) Pub. No.: US 2008/0098027 A1
(43) Pub. Date: Apr. 24, 2008

(54) Apparatus For And A Method Of Processing Reproducible Data

(75) Inventor: Ronaldus Maria Aarts, Geldrop (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,810

(22) PCT Filed: Dec. 21, 2005
(86) PCT No.: PCT/IB05/54362

§ 371 Date: Jun. 26, 2007

(30) Foreign Application Priority Data
Jan. 4, 2005 (EP) 05100029.7

(51) Int. Cl. G06F 7/00; G06F 17/00

(52) U.S. Cl. 707/102; 700/94; 707/E17.009; 707/E17.101

(57) ABSTRACT

An apparatus (100) for processing reproducible data comprises a receiving unit (103) adapted to receive reproducible data in a given order, and a processing unit (104) adapted to generate altered reproducible data by altering at least one property of received reproducible data in an at least partially random manner, wherein the alteration of at least one property is perceivable by a human sense when the altered reproducible data are reproduced in the given order.

### FIELD OF THE INVENTION

The invention relates to an apparatus for processing reproducible data.

The invention also relates to a method of processing reproducible data.

The invention further relates to a program element and a computer-readable medium.

### BACKGROUND OF THE INVENTION

Many new applications in the field of electronic entertainment devices are currently developed and introduced on the market.

Experience proves that, when a user has heard an audio excerpt (for example, a music song) several times, playback of this music excerpt may become boring to him.

In order to keep a user interested in audio excerpts for a long time, it is known to play a track list of an audio player in random order, so as to surprise the user or to prevent him from getting bored. This function is often available on a playback device, for example, a CD player, and is sometimes denoted as “shuffle” function.

US 2003/0046638 A1 discloses an apparatus for enhancing the value of pre-recorded content by randomly choosing alternative content segments at different points within the content, thereby potentially offering the user a different experience whenever the content is played.

U.S. Pat. No. 5,728,962 discloses a method of automatically rearranging a plurality of digital information units, comprising automatic reordering, repeating, and creating alternative sequences of the plurality of digital information units.

In other words, the cited prior art simply rearranges existing segments of content by randomly connecting segments of music, in order to change the order of segments of the content, similarly like a “shuffle” function on a CD player, but also within a track.

### OBJECT AND SUMMARY OF THE INVENTION

It is an object of the invention to provide reproducible data to a user in such a way that he gets surprised, thus avoiding that he becomes bored.

In order to achieve the object defined above, an apparatus and a method of processing reproducible data, a program element and a computer-readable medium as defined in the independent claims are provided.

The apparatus of processing reproducible data comprises a receiving unit adapted to receive reproducible data in a given order, and a processing unit adapted to generate altered reproducible data by altering at least one property of received reproducible data in an at least partially random manner, wherein the alteration of at least one property is perceivable by a human sense when the altered reproducible data are reproduced.

Moreover, the invention provides a method of processing reproducible data, the method comprising the steps of receiving reproducible data in a given order, and generating altered reproducible data by altering at least one property of received reproducible data in an at least partially random manner, wherein the alteration of at least one property is perceivable by a human sense when the altered reproducible data are reproduced.

Furthermore, a program element is provided, which, when being executed by a processor, is adapted to carry out a method of processing reproducible data in accordance with the above-mentioned steps.

A computer-readable medium is also provided, in which a computer program is stored which, when being executed by a processor, is adapted to carry out a method of processing reproducible data in accordance with the above-mentioned steps.

Reproducible data can be processed by means of a computer program, that is to say by software, or by using one or more special electronic optimization circuits, that is to say in hardware, or in a hybrid form, that is to say by means of software components and hardware components.

The characteristic features according to the invention particularly have the advantage that the at least partially randomized processing of reproducible data results in a different unexpected experience of perception, which can be enjoyed by a human user sensing the altered reproducible data when they are replayed. In other words, the processing method according to the invention prevents a user from feeling bored by repeatedly replaying reproducible playback data in the same manner, because the apparatus according to the invention varies the played back data whenever they are played back by adding some random contribution to the reproducible data. This alters the experience perceived by a user whenever the data are replayed. The invention thus enables a user to be entertained in an improved manner.

To maintain a human user's degree of interest at a high level, even when he has played back content already several times, the invention each time alters the replayed data by adding some randomness to the data, thus providing new altered data. In other words, the invention creates new data whenever a perceivable content is replayed, wherein the new data are always based on the original data, but are rearranged each time by including a random contribution, for example, a remix in which elements of a particular genre are emphasized (for example, typical elements of techno music, such as hard beats), whereas elements of other genres may be suppressed (for example, typical elements of classical music, such as a relatively high amount of reverberation). However, the invention does not only change the order of different segments of content, but generates new content, which content has not been existent before. Consequently, the user can enjoy an excerpt in a version he has never heard before.

In one embodiment, the invention further allows the user to see (for example, visible on a display) and/or store the previous random settings, so that these settings can be repeated for the next track or for future use, or sent to a friend, etc. when the user is particularly pleased about these settings.

In the apparatus of the invention, the receiving unit receives the reproducible data in a given order, and reproduces the altered reproducible data in—the same—given order. This means that, according to the invention, the order of the data is maintained, and the data are modified without reordering.

In a further embodiment of the invention, the apparatus is implemented as an audio player or a video player, which player remixes an audio or video track automatically whenever the track is played. Since the remix settings have a random character, a human user gets surprised whenever the data are reproduced. Thus, one aspect of the invention is directed to the automatic remix for audio players or video players.

The invention teaches to keep reproducible content itself in the same order, but to filter the content in a (pseudo)-random way. The random contribution gives the reproduced data a touch of diversification that cannot be foreseen by a human user. An optional pseudo-part may be steered by personal preference, the time of day, the history of previous selections, the repertoire (that is, rock music may be more heavily equalized than classical music), etc.

Another aspect of the invention is directed to the slight modification of a track of entertainment data whenever the entertainment data is replayed. When a user is watching or listening to the played back data, his feeling is thus a little bit different each time, such that he gets surprised or is prevented from getting bored. The invention thus has the important feature that, whenever a track is played, the processing operation acts on signals so that a track always sounds different. For example, a full remix can be made to sound such that a user can experience the same excerpt of audio or video data in very different ways from time to time.

For instance, each track of audio data may be equalized wherein “slider positions” may be chosen randomly, optionally biased by user preferences, the time of day (for example, less low frequency late at night; smoother and more relaxed audio mixing on Sundays), the user's age (for example, less techno character when the user is older than a threshold age), etc. The positions of the sliders of an equalizer (EQ) may thus be chosen in a random order.

The invention may be realized as a WinAmp™ module. Possible further applications of the invention are audio/video software and hardware players. For the latter, not only the audio content but also the video content can be changed, for example, the colors of the video replay. Another application relates to a slide show of pictures, wherein the colors or other image settings can be adjusted in a (pseudo)-random manner whenever the slide show is repeated.

The invention teaches a method in which a track is processed to change its perception properties whenever the track is played on a player (for instance, an audio player, a video player, a computer game player, a CD player or a WinAmp™ player). This processing operation may be an automatic remix, but it may also be just equalization. The remix/equalization settings can be determined randomly each time, or with a bias related to user preferences, for instance, pre-input by a user via a user interface.

Referring to the processing of audio data, the apparatus of the invention may have implemented an audio classifier for automatically classifying a type of content, that is to say a genre of audio music, for example, based on a spectral analysis of audio signals. For instance, one of the following two examples of classification types can be implemented in such a classifier, one on a set of five general audio classes, and a second on a set of popular music genres. The general audio classes are classical music, popular music (non-classical genre), speech (male and female, English, Dutch, German and French), crowd noise (applauding and cheering), and noise (background noise including traffic, fan, restaurant, nature). The popular music class may contain music of seven genres: jazz, folk, electronica, R&B, rock, reggae and vocal. The data can then be processed while considering the result of the classification, so that a pseudo-random contribution or restriction limits the manner in which data will be processed.

According to another aspect of the invention, the system may be auto-adaptive to learn user preferences. For instance, allowed equalizer settings can be limited in accordance with learned preferences. Thus, the randomness may be a limited randomness, for example, any random equalizer setting is limited to a range of settings that are compatible with user preferences.

More generally, the apparatus of the invention can introduce pseudo-random elements. These limitations, which render the randomness pseudo-random, may reflect user-related preferences, but may also depend on frame conditions of the environment in which the reproducible data is in fact reproduced. For instance, the apparatus can also measure environmental frame conditions, for instance, the speed of a runner using an audio player of the invention during jogging. Thus, the measured speed can be taken into account to influence the alteration of the reproducible data.

Further possible processing methods which may be implemented in the system of the invention are dynamic range control, volume and bass boost, the amount of stereo (base) widening, the balance between front and back channels in surround systems, etc.

Referring to the dependent claims, further preferred embodiments of the invention will be described hereinafter.

Preferred embodiments of the apparatus for processing reproducible data according to the invention will now be described. These embodiments may also apply to the method of processing reproducible data, the program element and the computer-readable medium.

The apparatus may comprise a reproduction unit adapted to reproduce the altered reproducible data. Such a reproduction unit may be an audio player, a video player, a computer on which an altered computer game is carried out, or the like. The reproduction unit may be a hard disk-based entertainment device. The apparatus of the invention may be a personal video recorder (PVR), which is an electronic device that records television shows to a hard disk in digital format. Another application of the invention is the PC-TV technology, which allows watching TV on a personal computer.

The processing unit may be adapted to process the reproducible data in a completely random manner. According to this embodiment, the data is altered in a purely random manner without deterministic limitations so that it is completely unforeseeable in which way the data will be played back the next time. This maximizes the surprising effect for a user.

Alternatively, the processing unit may be adapted to process the reproducible data in a pseudo-random manner. This means that some randomness is included in the reproducible data as a consequence of the manipulation step. However, some deterministic or pre-selected frame conditions are included to control the randomness to be added. In other words, the pseudo-random determination allows randomness within defined limits.

Referring to the latter embodiment, the processing unit may be adapted to process the reproducible data while considering at least one of the criteria of a group consisting of a user-defined processing criterion, a criterion depending on stored history data of a previous processing operation, content type of reproducible data, and a criterion reflecting a condition of reproduction.

For instance, the user may input a processing criterion, which will be taken into account when the reproducible data are manipulated to form the altered reproducible data. For this purpose, a user may limit equalizing parameters to a range which will never exceed or fall below a given value.

The degree of randomness can also be influenced by criteria depending on stored history data of a previous processing operation. For instance, the system may learn from former user preferences in an auto-adaptive manner. When a user limited a range of a perceivable parameter several times in the past, the system of the invention may recognize such a user preference from the history of the use of the device, and limit the pseudo-randomly estimated value of such a parameter for the future to values which the user liked in the past.

A content type of reproducible data can be used as a frame condition to control the manipulation of the data. For instance, an audio classifier may classify audio data, and inappropriate manipulations are avoided for the estimated class of audio content. For instance, it can be avoided that classical music is remixed to sound like techno music.

Furthermore, a criterion may reflect a condition of reproduction. If it is estimated that an environment in which audio data are currently played needs a particular manipulation of audio data, then the pseudo-random alteration of data can be performed accordingly. For instance, preferred ranges of parameters for equalizing audio data may be different when the audio data are played back via headphones as compared with a case in which audio data are played back via loudspeakers.

The processing unit may be adapted to process the reproducible data by filtering them.

Particularly, the processing unit may be adapted to process the reproducible data by equalizing them. Equalizing particularly means cutting and boosting individual frequencies of an audio signal using a number of filters. By taking this measure, audio signals may be corrected to improve the sound quality, or to render the sound closer to an original source.

The processing unit may be adapted to process the reproducible data by adding reverberation to them. Reverberation can be created artificially by a DSP (“Digital Signal Processing”) reverberator which can be implemented in the apparatus according to the invention and uses electronics and signal-processing algorithms to create an effect of reverberation through the use of large numbers of long delays with quasi-random length, optionally combined with equalization and other processes. By adding reverberation, the perception of audio can be modified significantly.

The processing unit may be adapted to process at least one of the group consisting of audio data, image data, video data, and computer game data as reproducible data. Thus, the invention includes, but is not limited to, performing any kind of audiovisual content in a manner that is interesting for a user. For instance, products like DVDs are available (mainly related to music concerts), on which alternative camera viewings are recorded which can be selected by the user in the conventional way. When playing back such a DVD with the system of the invention, a (pure or pseudo-)random automatic selection of a particular camera view can be made, that is to say a “main” view can be replaced by an alternative view, so that during watching the DVD, the content seems to be different whenever a user replays such a DVD.

The apparatus of the invention may be realized as an integrated circuit, particularly as a semiconductor integrated circuit. In particular, the system can be realized as a monolithic IC which may be manufactured in silicon technology.

The apparatus according to the invention may be realized as one of the group consisting of an audio player, a video player, a CD player, a DVD player, a virtualizer, an MP3 player, an internet radio device and a computer game apparatus.

According to the invention, the system may recognize that a song is played repeatedly. If a song (the same or a different one) each time gets a new random setting, the system does not necessarily need to know whether the song has been played before (for instance, today or yesterday). In another embodiment of the invention, the system may keep a track record (that is to say history data) of played records, and then the system knows which tracks have been played.

If the system knows how many times a particular audio item has been played, a pre-selected set of variations may be provided to the system (for instance, ten different possibilities of variations), and the audio piece may then only be varied in accordance with the pre-selected set of variations. According to this embodiment, the random aspect relates to the random selection of one of the pre-selected set of variations, and limiting the random selection to this pre-selected set of variations would then include a pseudo-random character. For example, when an audio item (like a song) is replayed for the fifth time, it will have the same selected fifth variation.

These and other aspects of the invention are apparent from and will be elucidated with reference to the embodiments described hereinafter.

### BRIEF DESCRIPTION OF THE DRAWINGS

The invention will be described in more detail hereinafter with reference to examples of non-limiting embodiments.

FIG. 1 shows an apparatus for processing reproducible data according to a preferred embodiment of the invention.

FIG. 2 shows a user interface of an apparatus for processing reproducible data according to an embodiment of the invention.

FIG. 3 shows randomly generated equalizer settings of the apparatus according to FIG. 2 at a first time an audio excerpt is replayed.

FIG. 4 shows randomly generated equalizer settings of the apparatus according to FIG. 2 at a second time the audio excerpt is replayed.

### DESCRIPTION OF EMBODIMENTS

The illustrations in the drawings are schematic. In the different drawings, similar or identical elements are denoted by the same reference numerals.

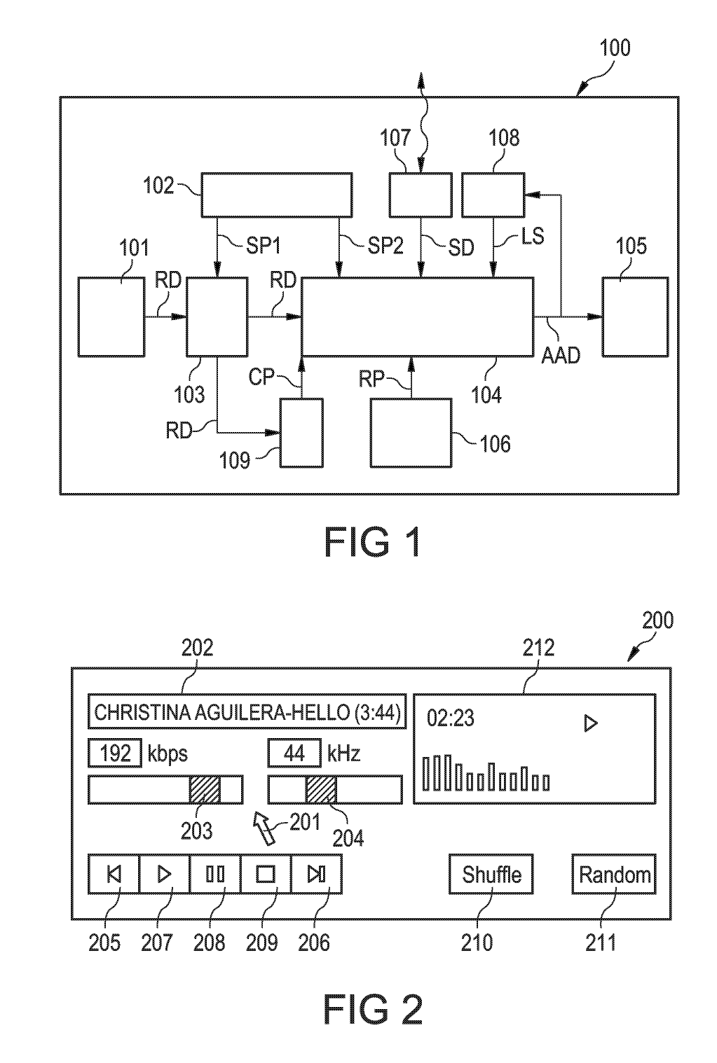

An audio player 100 according to a preferred embodiment of the invention will now be described in detail with reference to FIG. 1.

The audio player 100 comprises a hard disk 101, for example, a RAM memory or a flash memory, on which audio data to be replayed by the audio player 100 can be stored.

A user may control the functionality of the audio player 100 via a user interface 102 which comprises a plurality of selection buttons to select a desired operation mode of the audio player 100 and to adjust various parameters for storing, managing and replaying audio excerpts. Audio excerpts stored on the hard disk 101 and to be replayed by the audio player 100 can be selected through a corresponding selection by a user, carried out via the user interface 102 and resulting in one or more first selection parameters SP1.

If such an audio excerpt or a sequence of audio excerpts is selected by a user via the user interface 102, a receiving unit 103 receives reproducible data RD in accordance with the audio excerpt to be played back from the hard disk 101. The receiving unit 103 provides the reproducible data RD to a processing unit 104.

The processing unit 104 is a microprocessor (CPU) which is adapted to generate altered audio data AAD (that is to say modified reproducible data) by altering at least one property of the received reproducible data RD in a pseudo-random manner, wherein the alteration of at least one property is perceivable by a human sense when the pseudo-randomly modified reproducible data AAD are replayed.

As shown in FIG. 1, reproducible data RD (for example, MP3 audio files) which are stored on the hard disk 101 can also be provided to an audio classifier 109 which can carry out an audio classification, that is to say determine a genre to which the audio data excerpt is related. Such a genre might be, for instance, classical music, pop music, jazz, folklore, or the like. A corresponding classification parameter CP can be provided to the processing unit 104.

The user may influence the processing operation carried out by the microprocessor 104 by inputting respective user control commands via the user interface 102, resulting in one or more second selection parameters SP2.

A sensor unit 107 is provided, which can detect several environment parameters of the audio player 100, for example, the speed of a user using the audio player 100 during jogging, the temperature of the environment or reverberation properties of the environment (which may, for instance, be different in a church than outside a building). The sensor unit 107 is connected to the microprocessor 104 to provide these data or parameters as sensing data SD to the microprocessor 104.

Furthermore, a randomizer unit 106 for adding some randomizing character to the audio data to be processed is connected to the microprocessor 104 and provides one or more randomizing parameters RP to the microprocessor 104. The microprocessor 104 generates altered audio data AAD (that is to say processed reproducible data) at an output coupled to a reproduction unit 105 which is a loudspeaker in this case (alternatively, headphones can be used) for playback of the processed audio data AAD.

Moreover, the processed audio data are also provided to a learning unit 108 which is a self-adaptive unit that may also send a control signal (or learn signal LS) to the microprocessor 104 influencing the way of processing the audio data. The learning unit 108 may learn from the processed data which kind of processing fits the user preferences and can accordingly influence the processing of the data by the microprocessor 104. Thus, the loudspeaker 105 may reproduce the altered audio data AAD.

The microprocessor 104 processes the reproducible audio data in a pseudo-random manner, because it carries out a randomized processing of incoming audio data while considering deterministic frame conditions, namely user-defined processing criteria (input via the user interface 102), such as a criterion depending on stored history data of a previous processing operation (provided via the learning unit 108), a content type of reproducible audio data, namely the genre (provided by the audio classifier 109), and a criterion reflecting a mode or frame condition of reproduction, namely the jogging speed (detected by the sensor unit 107).

The microprocessor 104 filters the audio data, and particularly adjusts the equalizing properties of the reproducible data in a pseudo-random manner. This means that the microprocessor 104 adjusts an equalizer operation mode in accordance with a result of a randomized selection of equalizer parameters, but considers a user-defined range of acceptable equalizer parameters. In other words, the range of randomly obtained operation modes is limited in a user-defined manner. Furthermore, the microprocessor 104 randomly adds an amount of reverberation to the audio data.

The receiving unit 103 receives the reproducible audio data in a given order, as a sequence of frames or blocks. The microprocessor 104 generates the altered reproducible audio data in the same given order, without re-ordering the data.

As a consequence of the pseudo-random processing operation, the output audio data sound a little bit different whenever they are replayed, wherein the replayed audio data nevertheless fulfill given frame conditions.

FIG. 2 shows a user interface 200 of an apparatus for processing reproducible data according to an embodiment of the invention.

The user interface 200 may be realized as a window displayed on a monitor using Windows™ software of Microsoft™. Particularly, the user interface 200 may be realized as a modified WiAmp™ application.

A user may control the user interface 200 by means of a computer mouse (not shown) to move a mouse cursor 201 to a particular one of different selection buttons. The user may operate a track selection button 202 to select a particular audio item (for instance, “Hello” by singer Christina Aguilera), a volume adjustment button 203 for adjusting the loudness of replay, a balance adjustment button 204 for adjusting the balance of replay, a rewind button 205 for rewinding an audio piece, a fast-forward button 206 for fast winding an audio piece, a play button 207 for (re-)playing an audio piece, a pause button 208 for pausing an audio piece, a stop button 209 for stopping replay of an audio piece, etc. An information field 212 indicates information concerning the replay status of an audio excerpt.

By operating a shuffle button 210, a shuffle function can be switched on or off. When such a shuffle function is switched on, a track list of audio items is played in a random order. When such a shuffle function is switched off, a track list of audio items is played in a fixed order.

By operating a random button 211, a random function can be switched on or off. When such a random function is switched on, a particular audio item is played with random equalizer parameters that are newly estimated in a random manner whenever the audio item is played again. When such a random function is switched off, a particular audio item is played with fixed equalizer parameters whenever the audio item is played again.

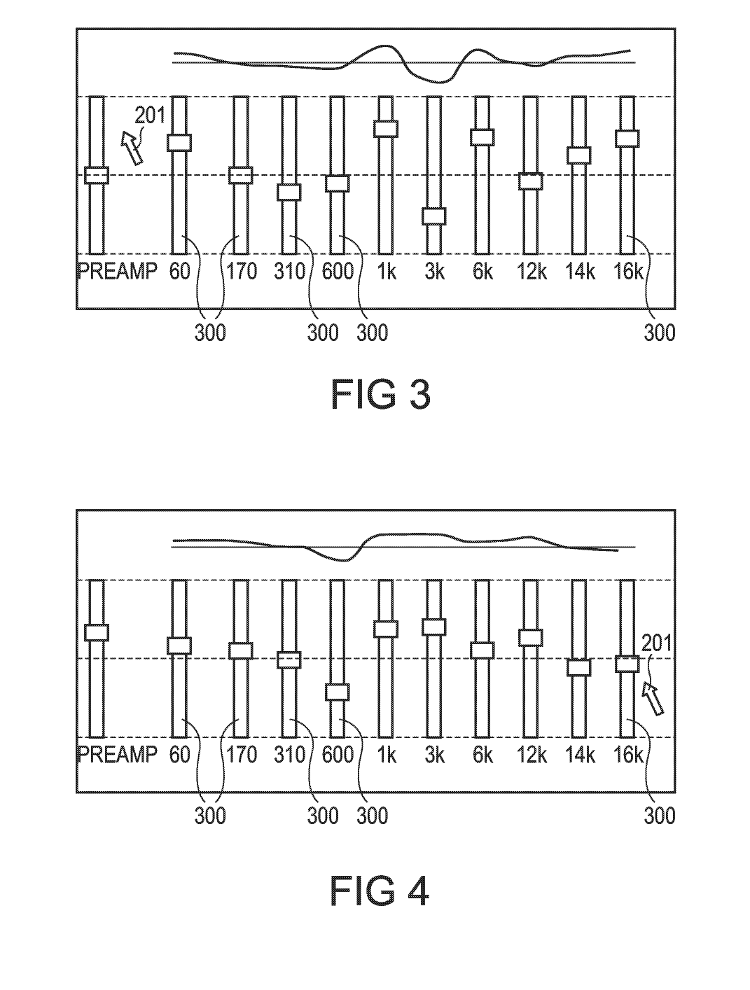

FIG. 3 shows randomly generated equalizer settings of an apparatus associated with the user interface 200 at a first time an audio excerpt is replayed. A particular equalizer setting is estimated in a random manner for each of a plurality of frequencies, so that the equalizer functionality is adjusted in accordance with the frequency equalizer bars 300. However, using the mouse cursor 201, which is controllable by means of a computer mouse (not shown), a user may optionally adjust each frequency equalizer bar 300 when he wishes to change any one of the randomly estimated setting parameters.

FIG. 4 shows randomly generated equalizer settings of an apparatus associated with the user interface 200 at a second time an audio excerpt is replayed. As illustrated in FIGS. 3 and 4, the random character of the equalizer settings estimation causes the frequency equalizer bars 300 to be adjusted in a different manner whenever a song is replayed, so that one and the same audio excerpt can be enjoyed by a human listener in a different manner whenever the audio excerpt is played back.

It should be noted that use of the verb “comprise” and its conjugations does not exclude elements or steps other than those stated in the claims, and use of the indefinite article “a” or “an” preceding an element or step does not exclude the presence of a plurality of such elements or steps. Moreover, elements described in association with different embodiments may be combined.

It should also be noted that reference signs in the claims shall not be construed as limiting the scope of the claims.

1. An apparatus (100) for processing reproducible data,
the apparatus (100) comprising:
a receiving unit (103) adapted to receive reproducible data in a given order; and
a processing unit (104) adapted to generate altered reproducible data by altering at least one property of received reproducible data in an at least partially random manner, wherein the alteration of at least one property is perceivable by a human sense when the altered reproducible data are reproduced in the given order.

2. The apparatus (100) according to claim 1,
further comprising a reproduction unit (105) adapted to reproduce the altered reproducible data.

3. The apparatus (100) according to claim 1,
wherein the processing unit (104) is adapted to process the reproducible data in a completely random manner.

4. The apparatus (100) according to claim 1,
wherein the processing unit (104) is adapted to process the reproducible data in a pseudo-random manner.

5. The apparatus (100) according to claim 4,
wherein the processing unit (104) is adapted to process the reproducible data while considering at least one of the criteria of the group consisting of:
a user-defined processing criterion,
a criterion depending on stored history data of a previous processing operation,
a content type of reproducible data, and
a criterion reflecting a condition of reproduction.

6. The apparatus (100) according to claim 1,
wherein the processing unit (104) is adapted to process the reproducible data by filtering them.

7. The apparatus (100) according to claim 1,
wherein the processing unit (104) is adapted to process the reproducible data by equalizing them.

8. The apparatus (100) according to claim 1,
wherein the processing unit (104) is adapted to process the reproducible data by adding reverberation to them.

9. The apparatus (100) according to claim 1,
wherein the processing unit (104) is adapted to process at least one of the group consisting of audio data, image data, video data, and computer game data as reproducible data.

10. The apparatus (100) according to claim 1,
realized as an integrated circuit.

11. The apparatus (100) according to claim 1,
realized as one of the group consisting of an audio player, a video player, a CD player, a DVD player, an MP3 player, a virtualizer, an internet radio device, and a computer game apparatus.

12. A method of processing reproducible data,
the method comprising the steps of:
receiving reproducible data in a given order; and
generating altered reproducible data by altering at least one property of received reproducible data in an at least partially random manner, wherein the alteration of at least one property is perceivable by a human sense when the altered reproducible data are reproduced in the given order.

13. A program element, which, when being executed by a processor (104), is adapted to carry out a method of processing reproducible data, the method comprising the steps of:
receiving reproducible data in a given order; and
generating altered reproducible data by altering at least one property of received reproducible data in an at least partially random manner, wherein the alteration of at least one property is perceivable by a human sense when the altered reproducible data are reproduced in the given order.

14. A computer-readable medium, in which a computer program is stored which,
when being executed by a processor (104), is adapted to carry out a method of processing reproducible data, the method comprising the steps of:
receiving reproducible data in a given order; and
generating altered reproducible data by altering at least one property of received reproducible data in an at least partially random manner, wherein the alteration of at least one property is perceivable by a human sense when the altered reproducible data are reproduced in the given order.
